(19) United States
(12) Patent Application Publication
(10) Pub. No.: US 2026/0148028 A1
(43) Pub. Date: May 28, 2026

(54) SHEET INFORMATION STORAGE APPARATUS, CONTROL METHOD, AND STORAGE MEDIUM

(71) Applicant: CANON KABUSHIKI KAISHA, Tokyo (JP)

(72) Inventor: HIROYA IGARASHI, Ibaraki (JP)

(21) Appl. No.: 19/374,788

(22) Filed: Oct. 30, 2025

(30) Foreign Application Priority Data
Nov. 25, 2024 (JP) 2024-204595

(51) Int. Cl. G06K 15/00; G06F 3/12

(52) U.S. Cl. CPC G06K 15/4065; G06F 3/1204; G06F 3/1253; G06K 15/002; G06F 3/1286

(57) ABSTRACT

A sheet information storage apparatus includes a storage unit configured to store sheet information, an addition unit configured to add a setting item and a default setting value of the setting item to the sheet information stored in the storage unit, a notification unit configured to provide a notification of sheet information for which the default setting value added by the addition unit is to be confirmed by a user, based on another setting value of another setting item of the sheet information stored in the storage unit before the default setting value is added by the addition unit, and a reception unit configured to receive, from the user, a change to the default setting value added by the addition unit.

### BACKGROUND

### Field of the Technology

The present disclosure relates to a sheet information storage apparatus, a control method of a storage apparatus, and a storage medium.

### Description of the Related Art

After the release of an image forming apparatus, a new post-processing apparatus that can be connected to and used with the image forming apparatus may be released, and as a result, a function for using a post-processing apparatus may be added to the image forming apparatus. The function is typically added by updating firmware, and Japanese Patent Laid-open No. 2012-190199 describes a technique for reducing the update time of the firmware by performing a difference update.

For example, in the production print market, an image forming apparatus capable of handling various types of sheets such as thin paper, thick paper, coated paper, and films is used, and sheet information is defined for each sheet and managed as a sheet list. The sheet information includes information about sheet attributes, such as basis weight and surface properties of a sheet, and adjustment values used when the sheet is used, such as an image position adjustment value and a secondary transfer voltage adjustment value.

As described in Japanese Patent Laid-open No. 2012-190199, in a case where sheet information such as a sheet attribute or an adjustment value is added by adding a function due to firmware update, the setting values of the sheet information added by the update are not necessarily optimum values. Thus, the user needs to confirm the sheet information of each sheet after the update of the firmware. On the other hand, depending on the added sheet information, there are some sheets for which confirmation is not necessary.

However, the user cannot determine which sheet information of sheets needs to be confirmed, even though the user wants to confirm only the sheet information of sheets that requires confirmation. In other words, it takes time and labor to identify the sheet information that requires confirmation after the sheet information is updated.

### SUMMARY

According to an aspect of the present disclosure, a sheet information storage apparatus includes a storage unit configured to store sheet information, an addition unit configured to add a setting item and a default setting value of the setting item to the sheet information stored in the storage unit, a notification unit configured to provide a notification of sheet information for which the default setting value added by the addition unit is to be confirmed by a user, based on another setting value of another setting item of the sheet information stored in the storage unit before the default setting value is added by the addition unit, and a reception unit configured to receive, from the user, a change to the default setting value added by the addition unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of an overall configuration of a print system according to one or more aspects of the present disclosure.

FIG. 2 is a mechanical cross-section diagram illustrating an image forming apparatus according to one or more aspects of the present disclosure.

FIGS. 3A and 3B are block diagrams respectively illustrating an example of a hardware configuration and an example of a software configuration of the image forming apparatus according to one or more aspects of the present disclosure.

FIGS. 4A and 4B are block diagrams respectively illustrating an example of a hardware configuration and an example of a software configuration of a print control apparatus according to one or more aspects of the present disclosure.

FIGS. 5A and 5B are diagrams respectively illustrating an example of a sheet template table and an example of a sheet setting management table included in the print control apparatus according to one or more aspects of the present disclosure.

FIGS. 6A and 6B are diagrams each illustrating an example of a sheet type management setting screen according to one or more aspects of the present disclosure.

FIG. 7 is a diagram illustrating an example of a sheet information detail edit screen according to one or more aspects of the present disclosure.

FIG. 8 is a flowchart illustrating an example of processing performed when a sheet information setting value is added, according to one or more aspects of the present disclosure.

FIGS. 9A and 9B are diagrams each illustrating an example of a notification screen according to one or more aspects of the present disclosure.

FIGS. 10A and 10B are diagrams each illustrating an example of a sheet type management setting screen according to one or more aspects of the present disclosure.

FIG. 11 is a flowchart illustrating an example of processing performed when a sheet information setting value is added, according to one or more aspects of the present disclosure.

FIG. 12 is a diagram illustrating an example of an update sheet template table according to one or more aspects of the present disclosure.

### DESCRIPTION OF THE EMBODIMENTS

Hereinafter, embodiments of the present disclosure will be described in detail with reference to the accompanying drawings. It should be noted that the following embodiments do not limit the present disclosure as defined in the claims, and not all combinations of features described in the embodiments are necessarily essential to the solutions of the present disclosure.

In the embodiments described below, a print system 100 is an example of a sheet information storage apparatus.

### First Embodiment

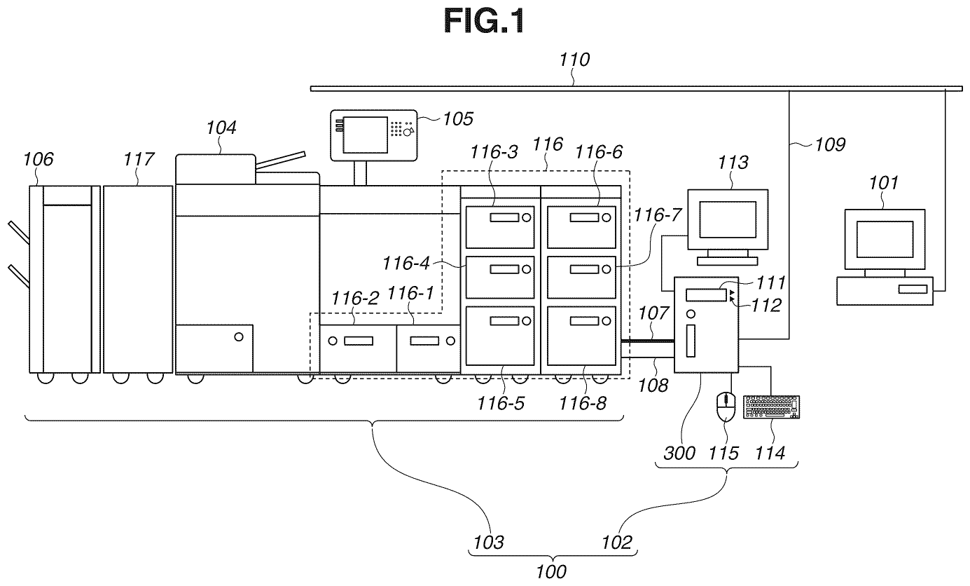

FIG. 1 is a diagram illustrating the overall configuration of the print system 100 according to a first embodiment.

The print system 100 includes an image forming apparatus 103 and a print control apparatus 102. The print system 100 is communicably connected to a client computer 101. The client computer 101 and the print control apparatus 102 are communicably connected to each other using an Ethernet cable 109 via a local area network (LAN) 110. The print control apparatus 102 and the image forming apparatus 103 are connected to each other via an image video cable 107 and a control cable 108. In the present embodiment, the image forming apparatus 103 is not directly connected to the LAN 110. The image forming apparatus 103 and the client computer 101 communicate with each other via the print control apparatus 102.

The image forming apparatus 103 may be connected to the LAN 110. In other words, the image forming apparatus 103 may be directly connected with the client computer 101 in a communicable manner. The client computer 101 activates an application to issue a print instruction or the like to the print system 100. The print control apparatus 102 performs image processing in cooperation with the image forming apparatus 103.

The image forming apparatus 103 is a multifunction peripheral or the like having various kinds of functions, and can copy data read by a scanner unit 104 and transmit it to a shared folder, in addition to performing image processing on the data transmitted from the client computer 101 or the print control apparatus 102. When an image scan is performed using the scanner unit 104, the scanner unit 104 receives various types of instructions from the user via various types of keys of an operation unit 105. The operation unit 105 displays various types of information, such as a scan state, via a panel.

A charge removal apparatus 117 is an apparatus for removing charge not completely removed by the image forming apparatus 103 to prevent the sheets discharged to a finisher 106 from adhering to each other. The finisher 106 receives and discharges a sheet with an image formed thereon.

The print control apparatus 102 includes a controller 300 and a display unit 111 that displays information of the print control apparatus 102 thereon. The user operates a hardware operation button unit 112 of the print control apparatus 102 to manipulate the information displayed on the display unit 111.

The various types of information displayed on the display unit 111 are used for the purpose of displaying information (e.g., operation of power and check of Internet Protocol (IP) address) required at least for operating the print control apparatus 102. In addition, an external display apparatus 113 of the print control apparatus 102, a keyboard 114, and a pointing device 115 are connected to the controller 300.

In the first embodiment, a description will be given of the print system 100 assuming that the print control apparatus 102 and the image forming apparatus 103 are separate systems; however, the processing of the print control apparatus 102 may be incorporated into the image forming apparatus 103, and the print control apparatus 102 may not be physically provided. The external display apparatus 113 may be configured to have a position input device function, such as a touch pad, and also functions as the pointing device 115.

Each of the sheet feed units 116-1 to 116-8 (also, collectively referred to as sheet feed units 116) connected to the image forming apparatus 103 is a device to store sheets to be used for printing, and when the image forming apparatus 103 receives a print instruction, one of the sheet feed units 116 is selected, and a sheet is fed from the selected one of the sheet feed units 116. The number of the sheet feed units 116 can increase or decrease depending on the optional configuration connected to the image forming apparatus 103.

Each of the sheet feed units 116-1 to 116-8 is provided with sheet guides for aligning the sheets stored therein by contacting the sheets at the trailing ends in the feed direction and the width direction of the stored sheets. The sizes of the width and the height of the stored sheets are detected by the sheet guides contacting the sheets in the width direction and the feed direction.

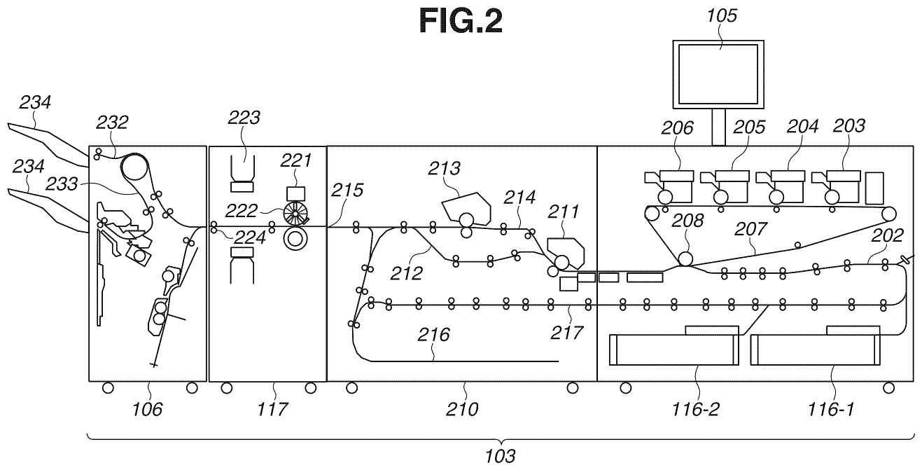

FIG. 2 is a mechanical cross-section diagram of the image forming apparatus 103 (in which the sheet feed units 116-3 to 116-8 are not illustrated) according to the first embodiment. This mechanical cross-section diagram is a cross-section diagram illustrating an example of the image forming apparatus 103. Hereinbelow, with reference to FIG. 2, the image forming apparatus 103 will be described.

A print engine 210 includes the sheet feed units 116-1 to 116-8 (the sheet feed units 116-3 to 116-8 are not illustrated). Each of the sheet feed units 116-1 to 116-8 can store various types of sheets. Each of the sheet feed units 116-1 to 116-8 separates only the uppermost sheet among the stored sheets and conveys the separated sheet to a sheet conveyance path 202. Developing stations 203 to 206 form toner images using color toners of yellow (Y), magenta (M), cyan (C), and black (K), respectively. First, the formed toner images are primarily transferred onto an intermediate transfer belt 207 in a sequential manner. Then, the intermediate transfer belt 207 rotates clockwise in FIG. 2, and the toner images are transferred by a secondary transfer roller 208 onto the sheet conveyed from the sheet conveyance path 202.

A first fixing unit 211 includes a pressure roller and a heating roller, and fixes the toner image onto the sheet by melting and pressing the toner image while the sheet passes between the rollers. The sheet that has passed through the first fixing unit 211 passes through a sheet conveyance path 212 and is conveyed to a sheet conveyance path 215. In a case where the type of sheet is a sheet type requires further melting and pressing of the toner image for fixing, the sheet is conveyed to a second fixing unit 213 through a sheet conveyance path 214 after passing through the first fixing unit 211.

The sheet on which additional melting and pressing have been performed by the second fixing unit 213 is conveyed to the sheet conveyance path 215. At this time, in a case where the print mode is set to double-sided printing, the sheet is conveyed to a sheet reversing path 216 to be reversed, and then the sheet is conveyed to a double-sided conveyance path 217. Then, the image transfer on the second surface of the sheet is performed by the secondary transfer roller 208.

The sheet conveyed from the print engine 210 is conveyed to the charge removal apparatus 117. The charge removal apparatus 117 includes a voltage application controller 221, a charge removal roller 222, and an ionizer 223, and is a portion for performing charge removal processing on the conveyed sheet. The sheet is conveyed by a conveyance roller 224 to the finisher 106.

The finisher 106 performs finishing processing on the conveyed sheet, such as stapling (one-point binding/two-point binding), punching (two-hole punching/three-hole punching), and saddle stitch bookbinding. The finisher 106 includes two trays 234. The sheet is discharged to one of the trays 234 through a sheet conveyance path 232 or 233.

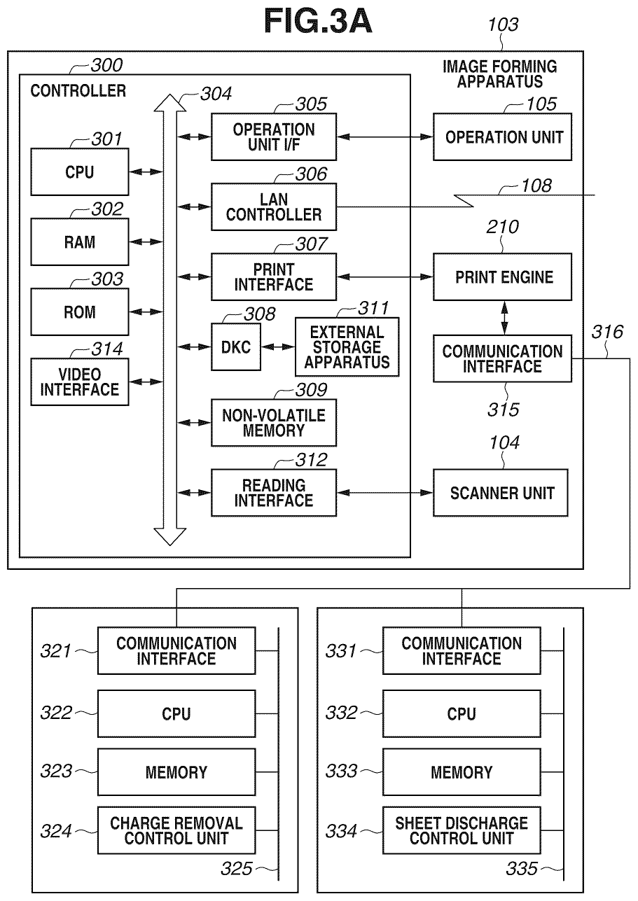

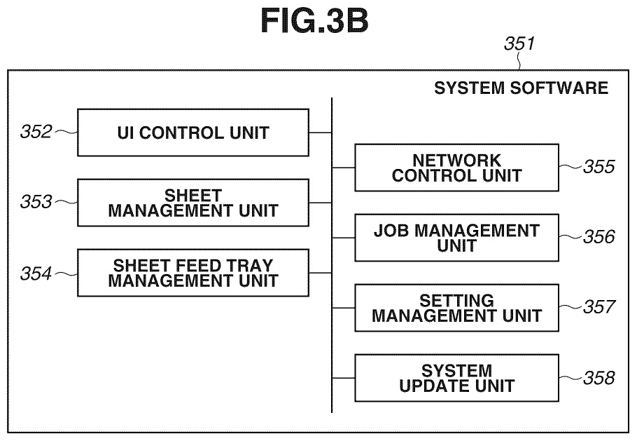

FIG. 3A is a block diagram illustrating an example of the hardware configuration of the image forming apparatus 103 according to the first embodiment.

The controller 300 includes a central processing unit (CPU) 301, which integrally controls various types of devices connected to a system bus 304, by loading a control program stored in a read only memory (ROM) 303 or an external storage apparatus 311 into a random access memory (RAM) 302 and executing the loaded program. For example, the CPU 301 outputs an image signal serving as output information to a printer engine (print unit) 210 connected via a print interface 307, and receives an image signal input from the scanner unit 104 connected via a reading interface 312. Further, the CPU 301 is connected to the print engine 210 via the print interface 307 to control each of the sheet feed units 116, and to acquire the state of each of the sheet feed units 116.

The print engine 210 issues a post-processing control instruction for the sheet discharged from the image forming apparatus 103 to the charge removal apparatus 117 and the finisher 106 connected to the print engine 210 by a communication cable 316 via communication interfaces 315, 321, and 331. Further, the CPU 301 can perform communication processing with the print control apparatus 102 via a LAN controller 306 and the control cable 108.

The RAM 302 mainly functions as a main memory, a work area, and the like for the CPU 301.

The access to the external storage apparatus 311 such as a hard disk drive (HDD) and a universal serial bus (USB) memory is controlled by a disk controller (DKC) 308. For example, the HDD is used for storing various types of information such as an application program, font data, form data, and sheet information, and also used as a job storage area for temporarily spooling jobs, and externally controlling the spooled jobs. Furthermore, the HDD is also used as a box data storage area for holding image data input from the scanner unit 104 or image data of print jobs as box data which can be referenced via the network or can be printed.

The USB memory is used for updating the firmware of the image forming apparatus 103 and the like. The operation unit 105 is connected to the controller 300 via an operation unit interface (I/F) 305, and the user can input various types of information using a software key or a hardware key. The operation unit 105 includes a display mechanism such as a touch panel and a display, and also functions as a display unit for displaying various types of information. A non-volatile memory 309 stores various types of setting information set from a terminal via the operation unit 105 or the LAN 110. A video interface 314 receives image data from the print control apparatus 102.

Next, the internal configuration of the charge removal apparatus 117 will be described. The charge removal apparatus 117 includes the communication interface 321, a CPU 322, a memory 323, and a charge removal control unit 324, which are connected with each other via a system bus 325. The communication interface 321 is connected with the print engine 210 via the communication interface 315, and performs communication necessary to remove the charge of the sheet. The CPU 322 controls the entire charge removal apparatus 117 based on a control program stored in the memory 323. The memory 323 is a storage device storing the control program. The charge removal control unit 324 controls the voltage application controller 221, the charge removal roller 222, and the ionizer 223 based on an instruction from the CPU 322 to perform charge removal processing on the sheet conveyed for charge removal.

Next, the internal configuration of the finisher 106 will be described. The finisher 106 includes the communication interface 331, a CPU 332, a memory 333, and a sheet discharge control unit 334, which are connected with each other via a system bus 335. The communication interface 331 is connected with the print engine 210 via the communication interface 315, and performs communication necessary to discharge the sheet. The CPU 332 controls the entire finisher 106 based on a control program stored in the memory 333. The memory 333 is a storage device storing the control program. The sheet discharge control unit 334 controls the conveyance and the discharge of the sheet based on an instruction from the CPU 332.

FIG. 3B is a block diagram illustrating an example of a software configuration of the image forming apparatus 103 according to the first embodiment. The functions of the blocks illustrated in FIG. 3B are implemented by the CPU 301 executing a program loaded into the RAM 302.

System software 351 controls the image forming apparatus 103. The system software 351 includes a user interface (UI) control unit 352, a sheet management unit 353, a sheet feed tray management unit 354, a network control unit 355, a job management unit 356, a setting management unit 357, and a system update unit 358.

The UI control unit 352 controls the operation unit 105 via the operation unit I/F 305. The UI control unit 352 can perform control to change the wording displayed on a screen and the display of the unit system for displaying a sheet size in accordance with the system settings.

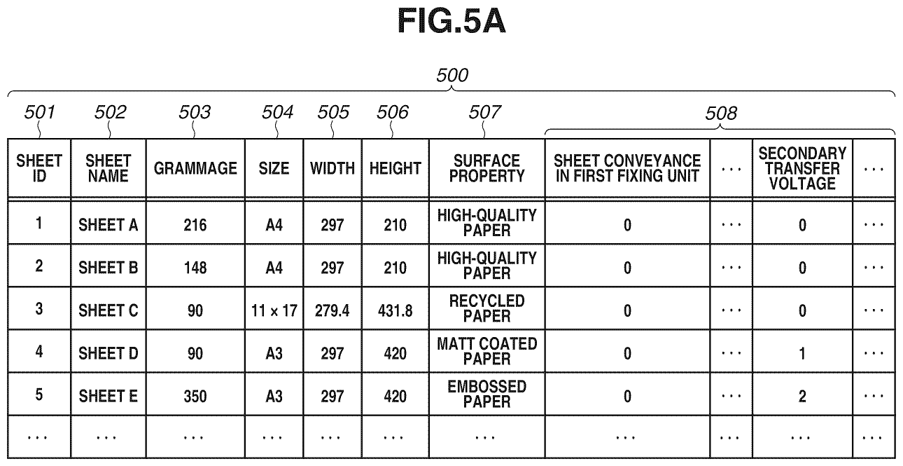

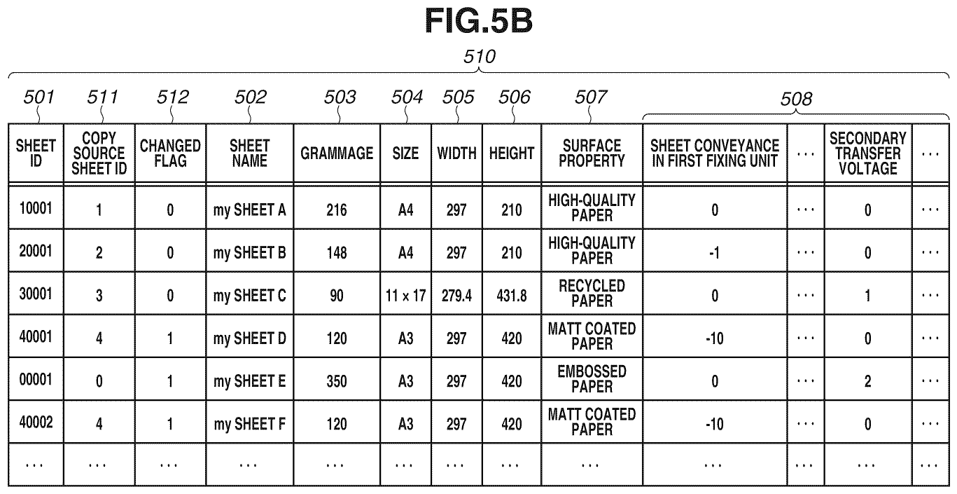

The sheet management unit 353 manages a sheet template table 500 in FIG. 5A and a sheet setting management table 510 in FIG. 5B. The sheet feed tray management unit 354 manages sheet information set in association with each of the sheet feed units 116. The sheet template table 500 and the sheet setting management table 510 may be stored in a storage unit such as the external storage apparatus 311 or an external storage apparatus 409, and the sheet information is stored in such a storage unit.

The network control unit 355 controls the communication with the print control apparatus 102 via the LAN controller 306. The job management unit 356 manages a print processing sequence and the order of jobs. The job management unit 356 controls data transfer for printing a job received from the print control apparatus 102 via the LAN controller 306 or the video interface 314, and manages the received jobs.

The setting management unit 357 manages the system settings related to a sheet management system. The system settings include, for example, a language setting for wording displayed on the screen of the sheet management system, and settings for the unit system (millimeters or inches) for displaying sheet sizes.

The system update unit 358 is responsible for updating the firmware of the image forming apparatus 103. The system update unit 358 reads the firmware stored in the external storage apparatus 311, such as a USB memory, via the DKC 308, and updates the control program stored in the ROM 303. The system update unit 358 also updates the sheet information stored in the HDD, in addition to firmware.

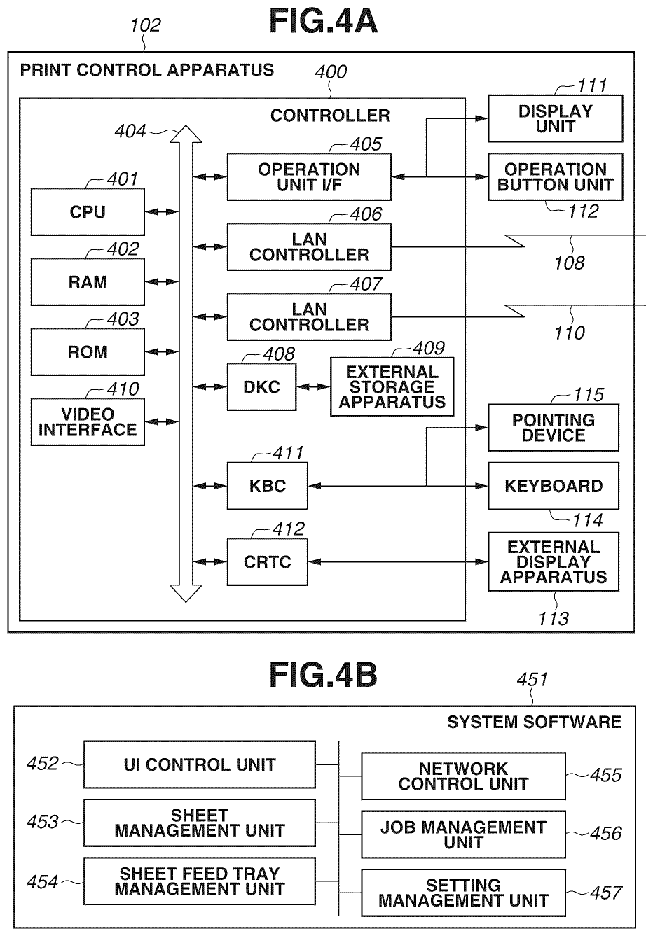

FIG. 4A is a block diagram illustrating an example of the hardware configuration of the print control apparatus 102 according to the first embodiment.

A controller 400 includes a CPU 401, and controls various devices connected to a system bus 404 by the CPU 401 loading a control program stored in a ROM 403 or the external storage apparatus 409 into a RAM 402 and executing the loaded program.

The CPU 401 can communicate with the image forming apparatus 103 via a LAN controller 406 and the control cable 108. The CPU 401 can perform communication processing with the client computer 101 and the image forming apparatus 103 on the network via a LAN controller 407 and the LAN 110.

The RAM 402 mainly functions as a main memory, a work area, and the like for the CPU 401.

The access to the external storage apparatus 409, such as an HDD and an integrated circuit (IC) card, is controlled by a DKC 408.

The external storage apparatus 409 stores an application program, font data, form data, and the like, and temporarily spools print jobs. The external storage apparatus 409 is also used as a job storage area for storing again the spooled jobs on which Raster Image Processor (RIP) processing has been performed.

An operation unit I/F 405 is an interface for connecting the controller 400 with the operation button unit 112 used by the user for inputting various types of information and the display unit 111 for presenting information to the user. A video interface 410 transmits the image data on which the RIP processing has been performed to the image forming apparatus 103.

The LAN controllers 406 and 407 connect the controller 400 with the control cable 108 and the LAN 110, respectively.

A keyboard controller (KBC) 411 performs processing related to the inputs from the keyboard 114 and the pointing device 115. A display control unit (Cathode Ray Tube Controller (CRTC)) 412 includes a video memory therein, and renders image data in the video memory in response to an instruction from the CPU 401, and also outputs the image data rendered in the video memory as a video signal to the external display apparatus 113.

FIG. 4B is a block diagram illustrating an example of the software configuration of the print control apparatus 102 according to the first embodiment. The functions of the blocks illustrated in FIG. 4B are implemented by the CPU 401 executing a program loaded into the RAM 402.

System software 451 that controls the print control apparatus 102 includes a UI control unit 452, a sheet management unit 453, a sheet feed tray management unit 454, a network control unit 455, a job management unit 456, and a setting management unit 457.

The UI control unit 452 controls a screen displayed in the print system 100. The UI control unit 452 can perform control to switch wording displayed on the screen and the display of the unit system for sheet sizes, according to the system settings.

The sheet management unit 453 communicates with the image forming apparatus 103, and handles the acquired sheet information. The data is held in a similar manner to the sheet template table 500 in FIG. 5A and the sheet setting management table 510 in FIG. 5B.

The network control unit 455 controls the communication with the image forming apparatus 103 via the LAN controller 406 and the communication with the client computer 101 on the LAN 110 via the LAN controller 407.

The job management unit 456 manages a print processing sequence and the order of jobs. The job management unit 456 manages a job received by the print control apparatus 102, and controls the data transfer for printing the received jobs to the image forming apparatus 103 via the LAN controller 406 or the video interface 410.

The setting management unit 457 manages the system settings related to the sheet management system. For example, the system settings include a language setting for wording displayed on the screen of the sheet management system, and settings for the unit system (millimeters or inches) for displaying sheet sizes.

FIG. 5A is a diagram illustrating an example of the sheet template table 500 included in the image forming apparatus 103 according to the first embodiment, and FIG. 5B is a diagram illustrating an example of the sheet setting management table 510.

The sheet template table 500 stores and manages not only information on commercially available sheets (such as name, grammage, and size) but also adjustment values (setting values) for respective setting items when the sheet is used in the image forming apparatus 103. The information on commercially available sheets may be registered in advance in the external storage apparatus 311. The information managed in the sheet template table 500 can be added and rewritten by, for example, updating (upgrading) the firmware.

In the sheet template table 500, size information, such as a sheet name 502, a grammage 503, a size 504, a width 505, and a height 506, a surface property 507, and a setting value 508 for each setting item are registered in association with a sheet identification (ID) 501 for identifying the sheet. Examples of the setting value 508 for each setting item include a sheet conveyance through the first fixing unit 211, a sheet conveyance through the second fixing unit 213, a transfer voltage, an image position adjustment, and a secondary transfer voltage.

The sheet setting management table 510 manages, in addition to the information in the sheet template table 500, information such as a copy source sheet ID 511, and a changed flag 512. In the sheet setting management table 510, the sheet information created by the user via the operation unit 105 is stored. The details regarding the creation of sheet information will be described below.

The copy source sheet ID 511 indicates the sheet ID 501 of the sheet serving as a copy source in the sheet template table 500. For example, in a case where the user copies a sheet A and newly defines (creates) “My Sheet A”, since the copy source sheet ID 501 corresponding to the sheet A managed in the sheet template table 500 is 1, the copy source sheet ID 511 is 1.

The sheet ID 501 in the sheet setting management table 510 is a value obtained by multiplying the value of the sheet ID 501, serving as a copy source, by 10,000 and adding a value indicating the order in which the sheet is created based on the copy source sheet. For example, in a case where the user defines “My Sheet D” based on a sheet D, and this is the first sheet defined based on paper D, the value becomes 4 (the sheet ID 501 corresponding to the sheet D managed in the paper template table 500)×10000+1 (order)=40001.

In a similar manner, in a case where the second paper is defined based on the sheet D (My Sheet F), the sheet ID 501 of the “My Sheet F” in the sheet setting management table 510 becomes 40,002. This sheet ID determination method is just an example, and is not limited thereto.

In a case where the user independently defines a sheet without using the sheet template table 500, the copy source sheet ID 511 becomes 0.

The changed flag 512 is set to 1 in a case where a sheet generated based on the sheet template table 500, the setting value of a setting item other than the sheet name 502 has been changed, and is set to 0 in a case where no change has been made. The value of the changed flag 512 is not limited to the case where a setting item other than the sheet name 502 has been changed, and the configuration may allow the user to set any setting item. In the present embodiment, an example will be described in which the changed flag 512 is set to 1 in a case where the user defines a sheet without using the sheet information in the sheet template table 500 (i.e., the copy source sheet ID 511 in the sheet setting management table 510 is 0).

The sheet management unit 353 edits, adds, deletes, and searches sheet information in the sheet setting management table 510 based on a user instruction.

The sheet template table 500 and the sheet setting management table 510 are management tables for managing sheet information for each sheet ID, and are stored, for example, in the external storage apparatus 311, which is a non-volatile storage area.

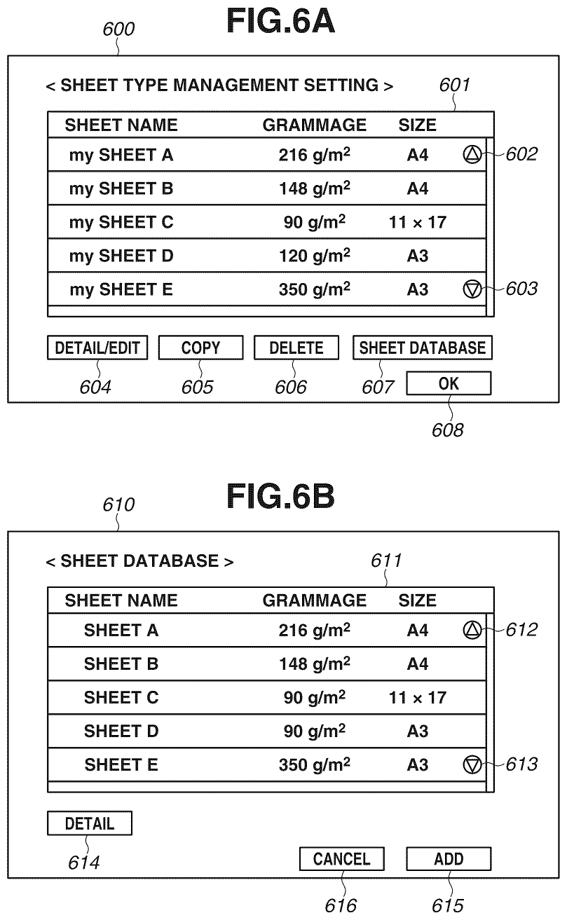

FIG. 6A illustrates a sheet type management setting screen 600 displayed on the operation unit 105 of the image forming apparatus 103 according to the first embodiment. This screen is displayed when the CPU 301 receives a user operation via the operation unit 105 and executes a control program stored in the ROM 303 or the external storage apparatus 311.

The sheet type management setting screen 600 displays a sheet list 601 of the sheets registered (managed) in the sheet setting management table 510. Scroll buttons 602 and 603 are buttons for scrolling the display of the sheet list 601. When the sheet list 601 managed in the sheet setting management table 510 cannot be fully displayed at once due to the size of the operation unit 105 or the like, the user can confirm the sheets in sequence by pressing the scroll button 602 or 603. In the present embodiment, an example in which “My Sheet F,” which is not displayed below “My Sheet E,” appears as a result of scrolling will be described below.

A detail edit button 604 is a button for displaying detailed information of a selected sheet, and when the detail edit button 604 is pressed, a detail edit screen 700 described below is displayed on the operation unit 105. On the detail edit screen 700, detailed information of a selected sheet is displayed, and various types of change buttons for changing the setting values of setting items corresponding to the selected sheet are further displayed.

A copy button 605 is a button for copying a selected sheet. When the copy button 605 is pressed, the CPU 301 copies the information of the selected sheet in the sheet setting management table 510, and reflects it on the sheet type management setting screen 600. A delete button 606 is a button for deleting the selected sheet information. When the delete button 606 is pressed, the CPU 301 deletes the information of the selected sheet in the sheet setting management table 510, and also reflects it on the sheet type management setting screen 600.

A sheet database button 607 is a button for displaying a sheet database screen 610 illustrated in FIG. 6B. An OK button 608 is a button for closing the sheet type management setting screen 600, and when the OK button 608 is pressed, the sheet type management setting screen 600 enters the state of no longer being displayed on the operation unit 105.

FIG. 6B illustrates the sheet database screen 610 displayed on the operation unit 105 of the image forming apparatus 103 according to the first embodiment. When the sheet database button 607 is pressed on the sheet type management setting screen 600, the CPU 301 causes the operation unit 105 to display the sheet database screen 610.

A sheet template list 611 registered (managed) in the sheet template table 500 is displayed on the sheet database screen 610. Scroll buttons 612 and 613 are buttons for scrolling the sheet template list 611. In a case where the sheet template list 611 managed in the sheet template table 500 cannot be fully displayed at once, the user can confirm the sheet templates in sequence by pressing the scroll button 612 or 613.

A detail button 614 is a button for displaying detailed information of a selected sheet template, and when the detail button 614 is pressed, the detailed information of the selected sheet is displayed on the operation unit 105.

An add button 615 is a button for adding a selected sheet to the sheet setting management table 510 (sheet type management setting screen 600). When the add button 615 is pressed, the CPU 301 adds and registers the selected sheet information to the sheet setting management table 510 based on the sheet template table 500. In this way, the added sheet is displayed on the sheet type management setting screen 600. A cancel button 616 is a button for closing the sheet database screen 610, and when the cancel button 616 is pressed, the sheet database screen 610 enters the state of no longer being displayed on the operation unit 105.

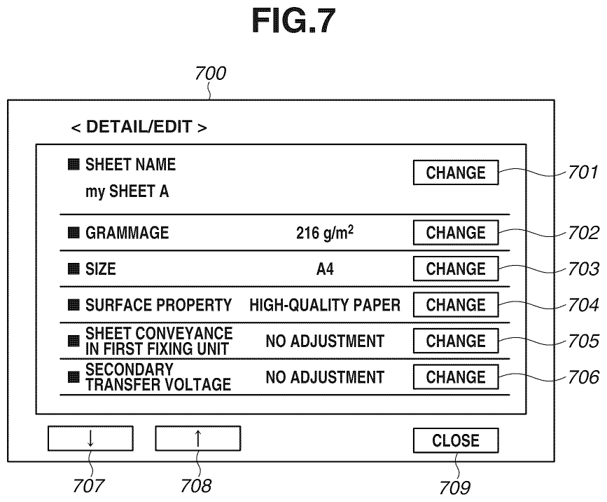

FIG. 7 illustrates the detail edit screen 700 of the sheet information displayed on the operation unit 105 of the image forming apparatus 103 according to the first embodiment. When the detail edit button 604 on the sheet type management setting screen 600 is pressed, the CPU 301 causes the operation unit 105 to display the detail edit screen 700. The setting change described below is performed by the user operating the operation unit 105, and is implemented by the CPU 301 receiving the user operation.

The setting value of the setting item (not illustrated) of the charge removal bias described in the present embodiment can also be changed via the detail edit screen 700. In a change made through the detail edit screen 700, including the charge removal bias setting, after a default setting value is added by a firmware update, the added default setting value can be changed.

A name change button 701 is a button for changing the setting value of a name corresponding to a selected sheet. When the name change button 701 is pressed, an input field (not illustrated) is displayed, and the user can set any desired name using keys or the like of the operation unit 105. A grammage change button 702 is a button for changing the setting value of a grammage corresponding to a selected sheet. When the grammage change button 702 is pressed, an input field (not illustrated) is displayed, and the user can set any desired value using keys or the like of the operation unit 105.

A size change button 703 is a button for changing the setting value of a size corresponding to a selected sheet. When the size change button 703 is pressed, size candidates, such as A3 and B5, are displayed, and the user can set the size by selecting a displayed candidate. A surface property change button 704 is a button for changing the setting value of a surface property corresponding to a selected sheet. When the surface property change button 704 is pressed, surface property candidates, such as matte-coated paper and glossy paper, are displayed, and the user can set the surface property by selecting a displayed candidate.

A sheet conveyance change button 705 for the first fixing unit is a button for adjusting the setting value for the first fixing unit 211 corresponding to a selected sheet. When the sheet conveyance change button 705 for the first fixing unit 211 is pressed, a setting screen (not illustrated) is displayed, and the user can set any desired value using keys or the like of the operation unit 105.

A secondary transfer voltage change button 706 is a button for adjusting the setting value of the secondary transfer voltage corresponding to a selected sheet. When the secondary transfer voltage change button 706 is pressed, a setting screen (not illustrated) is displayed, and the user can set any desired value using keys or the like of the operation unit 105.

A down button 707 is a button for displaying the next page. An up button 708 is a button for displaying the previous page. The user can confirm the sheets in sequence by pressing the down button 707 or the up button 708. A close button 709 is a button for closing the currently displayed screen, and when the close button 709 is pressed, the detail edit screen 700 enters the state of no longer being displayed on the operation unit 105.

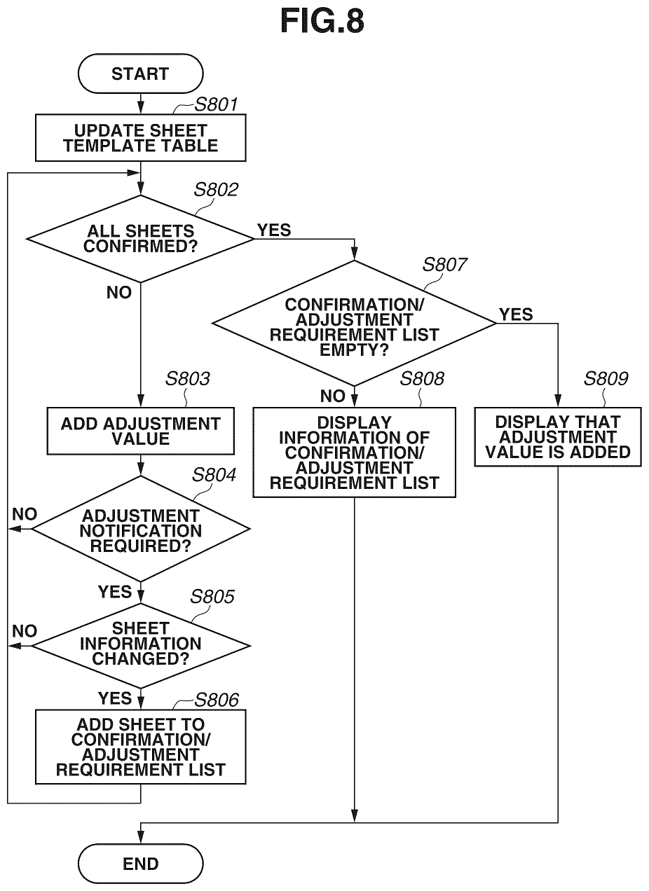

FIG. 8 is a flowchart illustrating an example of processing performed when a setting value of sheet information is added in the first embodiment. Examples of adding a setting value include a firmware update, and more specifically, a new setting value (adjustment value) corresponding to a new setting item is added.

In FIG. 8, a case where a setting item of a charge removal bias value for the charge removal apparatus 117, and a charge removal bias setting value are newly added is described as an example. It is assumed that the charge removal bias setting value to be added is initially set to the initial value (0) for each sheet registered in the sheet template table 500.

The processing illustrated in this flowchart is executed by the CPU 301, and starts when sheet information such as firmware update information is received.

The setting value that requires to be confirmed and adjusted is, for example, a setting value affected by changes in other parameters such as grammage, like the discharge removal bias value. In the present embodiment, an example in which a setting value for the setting item of a charge removal bias is newly added to the sheet template table 500 will be described.

In step S801, the CPU 301 replaces all setting values of existing setting items stored in the sheet template table 500 with new setting values. In a case where some of the existing setting values are updated to new setting values, the configuration may be such that only the corresponding setting values are updated.

At this time, in a case where a setting item that is not managed in the sheet template table 500 is newly added at the time of update, the setting item and the corresponding setting value (initial value) are added to the sheet template table 500 and stored (registered). In the present embodiment, an example in which the setting value 508 of the setting item of the charge removal bias is added to the setting information of all of the sheets registered in the sheet template table 500 will be described.

The CPU 301 may perform the update by deleting the sheet template table 500 stored at the time of update and newly saving a new sheet template table 500 in which the update contents are reflected.

In step S802, the CPU 301 determines whether all of the sheets in the sheet setting management table 510 have been confirmed. In a case where the CPU 301 determines that all of the sheets in the sheet setting management table 510 have been confirmed (YES in step S802), the processing proceeds to step S807. On the other hand, there are any unconfirmed sheets, i.e., the CPU 301 determines that not all of the sheets in the sheet setting management table 510 have been confirmed (NO in step S802), the processing proceeds to step S803.

In step S803, the CPU 301 adds the added setting value, i.e., the charge removal bias setting value, to the setting value 508 of the sheet setting management table 510. For example, in a case where the default value of the charge removal bias setting value is 0, 0 is added to all of the setting values of the setting items of the charge removal settings of the sheets registered in the sheet setting management table 510. For example, through the processing up to this point, the setting items and the default setting values thereof are added to the sheet information stored in the storage unit, as illustrated in the sheet template table 500.

In step S804, the CPU 301 determines whether it is necessary to provide a notification indicating that confirmation or adjustment is required for the added setting value. In other words, the CPU 301 determines whether the user is to confirm the added default setting value.

In the example of the present embodiment, the determination is made based on the surface property 507 managed in the sheet setting management table 510. In a case where printing is performed by a laser beam printer in an electrophotographic method, the printed sheet may become electrically charged due to the printing method. In a case where a plurality of electrically charged printed sheets is discharged just as they are, there is a risk that the charges on the sheets interact with each other and cause the printed sheets to undesirably adhere to each other. To prevent such the risk, the charge removal apparatus 117 removes the charge of the printed sheets based on the setting of the charge removal bias value.

This charge removal bias setting value is related to the surface property of a sheet, and in a case where the surface of the sheet is, for example, matte coated (matte coated sheet), since the sheet has a characteristic of easily accumulating electric charge, and therefore user confirmation or adjustment is required. Further, even within the category of matte coated sheets, the characteristics of the sheets may be different depending on the manufacture, and the user needs to set the charge removal bias setting value to match the sheet of the sheet manufacture. “My Sheet D” and the “My Sheet F” in the present embodiment are examples of such a case. This is an example in which they are the same in sheet parameter such as the grammage 503, but different in the surface property 507 even though they belong to the same category of matte coated sheets.

In the present embodiment, an example in which the CPU 301 determines whether a notification for adjustment is necessary based on whether the surface property 507 in the sheet setting management table 510 is a matte coated sheet will be described. More specifically, in a case where the surface property 507 in the sheet setting management table 510 is a matte coated sheet, the CPU 301 determines that it is necessary to notify that confirmation or adjustment is required.

More specifically, in the present embodiment, “My Sheet D” and “My Sheet F” correspond to the sheet information, which is to be confirmed by the user. The surface property 507 is an example of another setting value of another setting item of the sheet information stored in the storage unit before the default setting value of the setting item of the charge removal bias is added, and the notification is provided based thereon as described above.

The description is given of the example in which whether a notification for adjustment is required is determined based on the surface property 507 in the case where the setting item to be added is a charge removal bias. However, the criterion may change when the setting item to be added is different. For example, in an example in which the setting item of the secondary transfer voltage is added, the determination in step S804 may be performed based on the grammage 503 in the sheet setting management table 510. This is because the setting value of the secondary transfer voltage is dependent on the parameter of the grammage 503. More specifically, for example, the CPU 301 determines whether the grammage 503 is 120 (predetermined threshold value) or more, and in a case where the grammage 503 is 120 or more, the CPU 301 prompts the user to confirm the sheet information.

On the other hand, in a case where the grammage 503 is less than 120, the CPU 301 does not prompt the user to confirm the sheet information.

As an alternative to the above-described configurations, the print system 100 may be configured to receive the information for making the determination together with information on the firmware to be updated. The information for making the determination is, for example, information indicating whether to perform a display for prompting adjustment, and the CPU 301 can perform the determination in step S804 by using this information. In other words, in a case where the firmware update information includes information indicating, for each piece of the sheet information, that confirmation or adjustment of the setting value of the setting item to be added by this update is required, the CPU 301 determines whether the notification is required to be made for each piece of the sheet information.

In a case where the CPU 301 determines that the notification is required to be made (YES in step S804), the processing proceeds to step S805. On the other hand, in a case where the CPU 301 determines that the notification is not required to be made (NO in step S804), the processing returns to step S802.

In step S805, the CPU 301 determines whether the sheet information has been changed based on whether the changed flag 512 is 1. As described above, the changed flag 512 is set to 1 in the case where the setting value of a setting item other than the sheet name 502 is changed, and set to 0 in the case where no change is made, as for the sheet defined by the user based on the sheet template table 500. Since the value is determined before adding the setting value, the determination in this step can be made based on the value of the changed flag 512. In this way, in the case where the sheet information other than the sheet name 502 has been changed, i.e., in a case where the changed flag 512 is 1 (YES in step S805), the processing proceeds to step S806, and in a case where the changed flag 512 is 0 (NO in step S805), the processing returns to step S802.

In step S806, the CPU 301 adds the sheet determined in step S805 to have its sheet information changed to a list of sheets that require confirmation or adjustment. More specifically, for example, the CPU 301 stores the sheet ID 501 and the sheet name 502, as a list, in the sheet setting management table 510 corresponding to the sheet. In the present embodiment, the description is given assuming that the CPU 301 determines that the sheet information of the sheets having sheet IDs 501=40001, 00001, and 40002 ,i.e., “My Sheet D”, “My Sheet E”, and “My Sheet F,” is changed, and they are added to the list of sheets that require confirmation or adjustment.

In step S807, the CPU 301 determines whether the list of sheets that require confirmation or adjustment, which has been made by the processing in steps S802 to S806 is empty. In step S807, in a case where the CPU 301 determines that the list is empty (YES in step S807), the processing proceeds to step S809. On the other hand, in step S807, in a case where the CPU 301 determines that the list is not empty (NO in step S807), the processing proceeds to step S808.

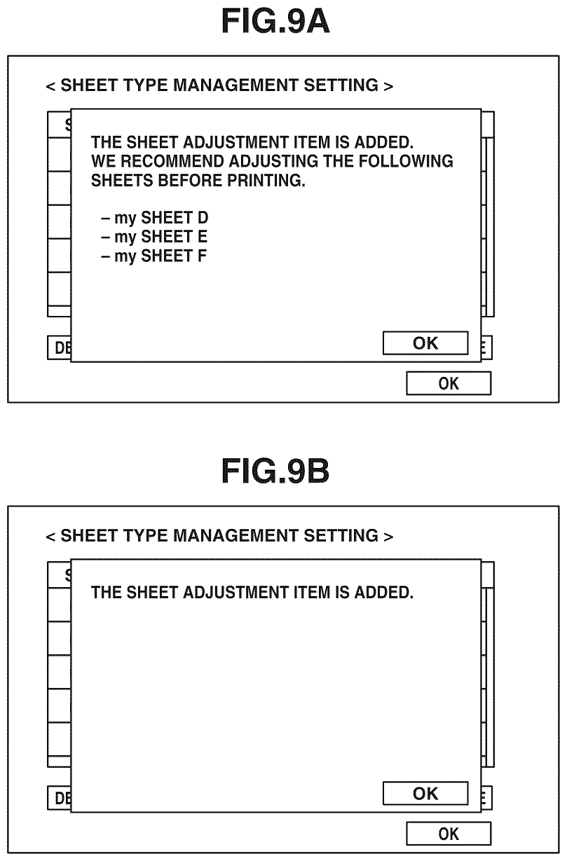

In step S808, the CPU 301 causes the operation unit 105 to display information on the sheets that are listed as requiring confirmation or adjustment, and notifies the user. FIG. 9A illustrates an example of such a notification. In FIG. 9A, “My Sheet D” and “My Sheet F,” which each have the surface property 507 of matte coated, are notified as sheets that require confirmation or adjustment. In addition, “My Sheet E”, which is a sheet defined by the user without using the sheet in the sheet template table 500, is also notified as a sheet that requires confirmation or adjustment. When the notification is completed, this processing ends.

In step S809, the CPU 301 causes the operation unit 105 to display that a setting value has been added and the update has been completed. FIG. 9B illustrates an example of such a screen. This processing ends when the display is completed. The processing in step S809 is not essential, and the processing of the flowchart may end without performing the processing in step S809.

FIG. 9A is a diagram illustrating an example of a notification screen that displays information on the sheets listed by the processing described with reference to FIG. 8, as sheets for which confirmation or adjustment is recommended due to the update, and is displayed on the operation unit 105. In FIG. 9A, the names in the sheet name 502 stored in the sheet setting management table 510 corresponding to the listed sheets are displayed in a list form. In the example in FIG. 9A, since “My Sheet D”, “My Sheet E”, and “My Sheet F” are added to the list of sheets that require confirmation or adjustment in step S806, these sheet names in the sheet name 502 are displayed. In this case, the sheet information other than the sheet information of which the added setting value is to be confirmed by the user is not displayed.

From the viewpoint of usability, the sheet name 502 is desirably displayed, but it is not limited thereto, and, for example, the information managed in the sheet setting management table 510, such as the sheet ID 501, may be displayed.

In the example in FIG. 9A, information of sheets that are not added to the list is not displayed; however, the present embodiment is not limited to this. For example, all of the sheets registered in the sheet setting management table 510 may be displayed in a list form, and only the information on the sheets corresponding to the sheets added to the list may be displayed in a distinguishable manner. For example, the above-described configuration may be achieved, for example, by changing the text color for displaying the sheet information, changing the background color of the field for displaying the sheet information, or displaying an object around the text for displaying the sheet information. FIG. 9B is a diagram illustrating an example of an update completion screen displayed on the operation unit 105. On the screen, a character string indicating that an adjustment item (setting item) of the sheet is added. This character string is not limited to this example.

As described above, when a sheet setting value is added, it becomes possible to display the sheets that require confirmation or adjustment in a list form, by extracting the sheets of which the sheet information has been changed by the user. In this way, the user can easily identify the sheets for which confirmation or adjustment is required. Thus, this has an effect of reducing the time and labor for identifying the items that require to be confirmed after the update of the sheet information.

In the present embodiment, the changed flag 512 is set to 1 in the case where an item other than the name is changed, but it may be set to 1, for example, only in a case where a specific sheet attribute such as grammage is changed, or in a case where a specific adjustment value such as a secondary transfer voltage adjustment is changed. The changed flag 512 may be set to 1 based on a combination of a specific attribute and a setting value. In this way, the attributes or the setting values of the sheets affected by the added setting values may be limited such that, for example, the confirmation/adjustment display is not performed even when the sheet color is changed.

### Second Embodiment

In the first embodiment, in the case where a setting value is added, the screen displaying a list of sheets requiring confirmation or adjustment is displayed on the operation unit 105; however, there is no method for the user to confirm the list of sheets requiring confirmation or adjustment after the screen is closed. In consideration of this point, in a second embodiment, processing of performing a display indicating which sheet in the sheet type management setting screen 600 requires confirmation or adjustment will be described.

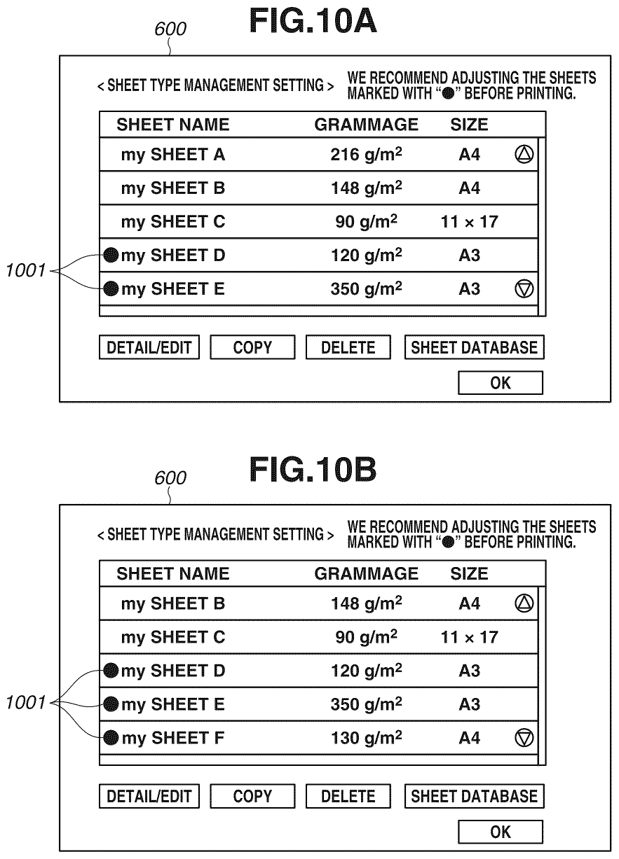

The CPU 301 holds, in the non-volatile memory 309, the list of sheets that require confirmation or adjustment, which is created in step S806, and displays the sheet type management setting screen 600 with confirmation marks 1001 indicating that the setting values of the corresponding sheets need to be confirmed or adjusted. An example of this will be described with reference to FIGS. 10A and 10B.

FIGS. 10A and 10B are diagrams each illustrating an example of the sheet type management setting screen 600 in which the confirmation marks 1001 are added to the sheets requiring confirmation or adjustment. In FIGS. 10A and 10B, a filled circular object is displayed on the left side of the sheet name 502 corresponding to the sheets, so that they are displayed in a manner distinguishable from the sheets not in the list. In addition, on the upper part of the screen, a message for prompting the user to confirm and adjust the setting values is described, i.e., “WE RECOMMEND ADJUSTING THE SHEETS WITH ‘•’ BEFORE PRINTING.” is displayed. In this way, the default setting values of the sheet information that are to be confirmed by the user are displayed in a distinguishable manner.

FIG. 10A is a diagram illustrating an example in which not all the sheets registered in the sheet setting management table 510 are displayed on the screen, and FIG. 10B is a diagram illustrating an example of the sheet type management setting screen 600 in a state where “My Sheet F” newly appears on the screen as a result of scrolling. In FIGS. 10A and 10B, in contrast to FIG. 9A, the sheet information other than the sheet information for which the user needs to confirm the added setting value is also displayed. The configuration may be also such that sheet information other than the sheet information for which the user needs to confirm the added setting value may not be displayed.

The object is not limited to the filled circular object, and may be, for example, in a star shape. The position where the confirmation mark 1001 is displayed is not limited to the left side of the sheet name 502. It is sufficient that the confirmation mark 1001 is attached to the corresponding sheet so that it is displayed in a manner distinguishable from sheets not in the list. The confirmation mark 1001 is not limited to an object, and may be a character string for prompting the user to perform confirmation or adjustment, such as “Confirmation Required” and “Changed”.

The confirmation mark 1001 becomes no longer displayed when a detail screen or a change screen of the setting value of the corresponding sheet is displayed, or when the setting value is changed. This timing may be arbitrarily selected by the designer.

In this way, the timing for deleting the confirmation mark 1001 may be different depending on the setting value.

For example, in a case of a setting value that does not necessarily require adjustment, such as a setting value of a folding position adjustment that is determined in relation to print data, the confirmation mark may be deleted when the user presses the detail edit button 604 for the sheet to display the detailed information, and the detailed information screen returns to the sheet type management setting screen 600. On the other hand, in a case of a sheet for which it is desirable to change the setting value before printing, such as a charge removal bias value, the confirmation mark 1001 may be deleted after adjustment is actually performed. The term “adjustment” in this case means that the setting change screen is displayed or the setting value is actually changed by the user.

Naturally, when such a screen transition occurs and the user returns to the sheet type management setting screen 600, the confirmation marks 1001 for the sheets that has been confirmed or adjusted disappear, and the confirmation marks 1001 continue to be displayed for the sheets that are in the list and have not confirmed or adjusted. In this way, the user can confirm or adjust the setting value of each item of the sheets without omission, by confirming or adjusting the settings of the sheets for which the confirmation marks 1001 are displayed.

As described above, by displaying the sheet information on the sheets requiring confirmation or adjustment on the sheet list display screen, it becomes possible to confirm whether adjustment of the added setting value is required even at a time other than the firmware update time.

### Third Embodiment

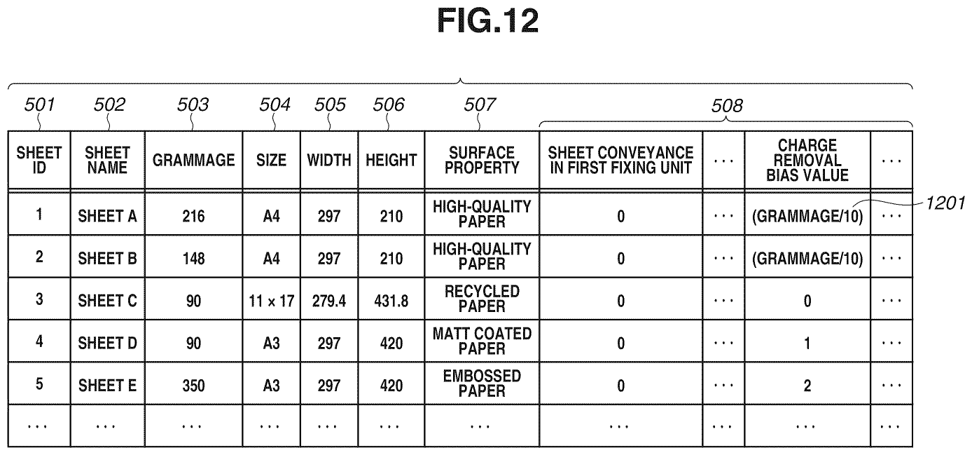

In the first embodiment, in the case where the sheet information has been changed, confirmation or adjustment is always required; however, there is a case where confirmation or adjustment is not necessarily required, and the processing in such a case will be described in the present embodiment. For example, there is a case where the grammage value of a sheet and an adjustment value thereof are proportional when the grammage values of sheets of the same series from a certain manufacturing company are different. For example, as illustrated in FIG. 12, a case is illustrated in which a proportional relationship appears in the charge removal bias value between sheets such as Sheet A and Sheet B. In this case, since the adjustment value can be set by calculating the adjustment value using a calculation formula even when the grammage value is changed, adjustment can be automatically performed without requiring confirmation or adjustment by the user. This is just an example, and as long as the adjustment value can be calculated from the information of another sheet, it is not limited to the information of a specific sheet and a specific calculation formula.

FIG. 12 is a diagram illustrating an example of an update sheet template table 1201. In FIG. 12, a case where the setting value 508 for the charge removal bias can be calculated as the grammage divided by 10 (grammage/10) is illustrated as an example. More specifically, even in a case where the setting value is changed by the update and is originally a setting value that requires confirmation or adjustment, the setting value 508 for the charge removal bias can be calculated by referring to the setting value of another setting item (grammage). Since requiring the user to perform confirmation or adjustment even in this case would impair usability, it is desirable to automatically calculate the setting value 508 for the charge removal bias and not to provide a notification prompting the user to perform confirmation or adjustment.

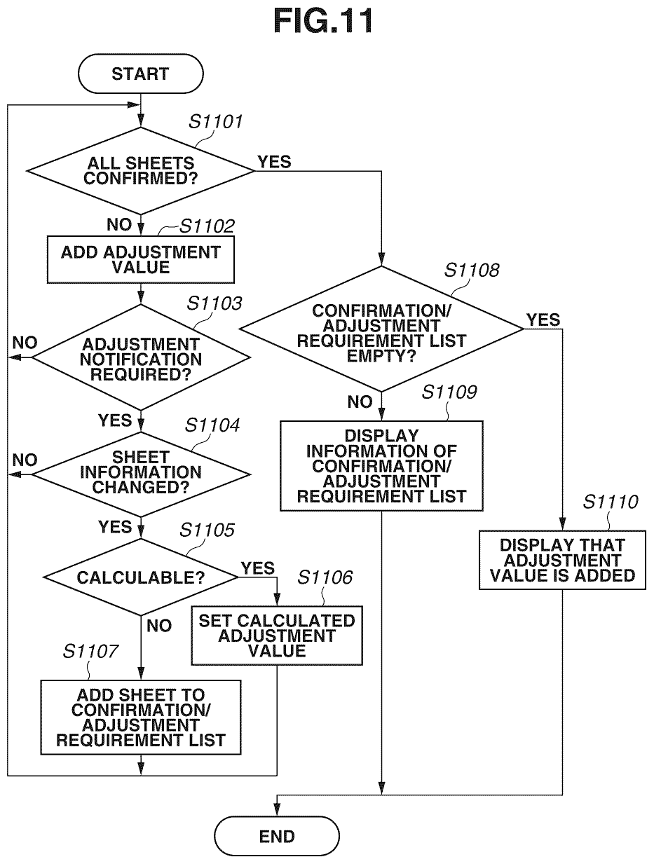

FIG. 11 is a flowchart illustrating an example of processing in which a determination of providing a notification is made based on whether the setting value is calculable according to the third embodiment. In the same manner as the first embodiment, this processing starts when an adjustment value is added due to an update of firmware or the like. The processing in this flowchart is executed by the CPU 301. Processing performed in steps S1101 to S1104 is similar to the processing performed in steps S801 to S804, and thus, the description thereof is omitted.

In step S1105, the CPU 301 determines whether the added setting value is calculable. More specifically, the CPU 301 makes the determination based on whether the added setting value is a numeric value or a calculation formula, and in a case where the added setting value is a calculation formula, the CPU 301 determines that the added setting value is calculable, and in a case where the added setting value is a numeric value, the CPU 301 determines that the added setting value is not calculable.

In step S1105, in a case where the CPU 301 determines that the added setting value is calculable (YES in step S1105), the processing proceeds to step S1106. On the other hand, in step S1105, in a case where the CPU 301 determines that the added setting value is not calculable (NO in step S1105), the processing proceeds to step S1107.

In step S1106, the CPU 301 calculates the setting value based on the calculation formula, and sets the calculated value.

For example, in a case where the sheet created from Sheet A, i.e., the sheet ID 511 serving as a copy source is 1, the value of the grammage divided by 10 (grammage/10) is set as the charge removal bias value. In steps S1105 and S1106, a script for calculating the setting value may be included in a firmware update program separately from the update data of the sheet information, and the setting value may be set using the script.

Processing performed in steps S1107 to S1110 is similar to the processing performed in steps S806 to S809, and thus, the description thereof is omitted.

As described above, in the case where the setting value is calculable even when the sheet information is changed, it becomes possible to set an appropriate value without providing a notification prompting the user to perform confirmation or adjustment.

### Other Embodiments

The present disclosure may also be implemented by supplying a program that realizes one or more functions of the above-described embodiments to a system or apparatus via a network or a storage medium, and causing one or more processors of a computer in the system or apparatus to read and execute the program. Alternatively, the present disclosure may be implemented by a circuit (e.g., an Application Specific Integrated Circuit (ASIC)) that realizes one or more functions.

According to the present disclosure, it is possible to reduce the time and labor for identifying sheet information that needs to be confirmed by the user after the sheet information has been updated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204595, filed Nov. 25, 2024, which is hereby incorporated by reference herein in its entirety.

What is claimed is:

1. A sheet information storage apparatus comprising:
a storage unit configured to store sheet information;
an addition unit configured to add a setting item and a default setting value of the setting item to the sheet information stored in the storage unit;
a notification unit configured to provide a notification of sheet information for which the default setting value added by the addition unit is to be confirmed by a user, based on another setting value of another setting item of the sheet information stored in the storage unit before the default setting value is added by the addition unit; and
a reception unit configured to receive, from the user, a change to the default setting value added by the addition unit.

2. The sheet information storage apparatus according to claim 1, wherein the notification unit displays the sheet information in an identifiable manner.

3. The sheet information storage apparatus according to claim 2, wherein the displayed sheet information is a name of a sheet.

4. The sheet information storage apparatus according to claim 3, wherein the notification unit displays the sheet information in an identifiable manner by displaying the name of the sheet stored in the storage unit in association with the sheet and an object.

5. The sheet information storage apparatus according to claim 4, wherein the notification unit displays the sheet information including sheet information other than the sheet information for which the setting value added by the addition unit is to be confirmed by the user.

6. The sheet information storage apparatus according to claim 2, wherein the notification unit displays, among the sheet information stored in the storage unit, the sheet information for which the setting value added by the addition unit is to be confirmed by the user.

7. The sheet information storage apparatus according to claim 6, wherein the notification unit does not display sheet information other than the sheet information for which the setting value added by the addition unit is to be confirmed by the user, among the sheet information stored in the storage unit.

8. The sheet information storage apparatus according to claim 1, wherein the added setting value is a charge removal bias setting value, and the another setting value of the another setting item is a surface property.

9. The sheet information storage apparatus according to claim 1, wherein the notification unit provides the notification of the sheet information for which the setting value added by the addition unit is to be confirmed by the user, based on the setting value added by the addition unit.

10. The sheet information storage apparatus according to claim 1, wherein the notification unit does not provide the notification in a case where the added setting item is calculable.

11. A control method of a storage apparatus comprising:
storing sheet information in a storage unit;
adding a setting item and a default setting value of the setting item to the sheet information stored in the storage unit;
providing a notification of sheet information for which the added default setting value is to be confirmed by a user, based on another setting value of another setting item of the sheet information stored in the storage unit before the default setting value is added; and
receiving a change to the added default setting value from the user.

12. The control method of the storage apparatus according to claim 11, wherein, in the providing the notification, the sheet information is displayed in an identifiable manner.

13. The control method of the storage apparatus according to claim 12, wherein the displayed sheet information is a name of a sheet.

14. The control method of the storage apparatus according to claim 13, wherein, in the providing the notification, the sheet information is displayed in an identifiable manner by displaying the name of the sheet stored in the storage unit in association with the sheet and an object.

15. The control method of the storage apparatus according to claim 14, wherein, in the providing the notification, the sheet information is displayed, including sheet information other than the sheet information for which the added setting value is to be confirmed by the user.

16. The control method of the storage apparatus according to claim 12, wherein, in the providing the notification, the sheet information for which the added setting value is to be confirmed by the user is displayed, among the sheet information stored in the storage unit.

17. The control method of the storage apparatus according to claim 16, wherein, in the providing the notification, sheet information other than the sheet information for which the added setting value is to be confirmed by the user is not displayed, among the sheet information stored in the storage unit.

18. The control method of the storage apparatus according to claim 11, wherein the added setting value is a charge removal bias setting value, and the another setting value of the another setting item is a surface property.

19. The control method of the storage apparatus according to claim 11, wherein the notification of the sheet information for which the added setting value is to be confirmed by the user is provided based on the added setting value.

20. The control method of the storage apparatus according to claim 11, wherein in a case where the added setting item is calculable, the notification is not provided.

21. A non-transitory computer readable storage medium for storing a program causing a computer to execute the control method, the method comprising:
storing sheet information in a storage unit;
adding a setting item and a default setting value of the setting item to the sheet information stored in the storage unit;
providing a notification of sheet information for which the added default setting value is to be confirmed by a user, based on another setting value of another setting item of the sheet information stored in the storage unit before the default setting value is added; and
receiving a change to the added default setting value from the user.
